(19) United States
(12) Patent Application Publication
(10) Pub. No.: US 2024/0043696 A1
(43) Pub. Date: Feb. 8, 2024

(54) RADIATION-CURABLE (METH)ACRYLATE-BASED PAINT SYSTEM

(71) Applicant: GXC Coatings GmbH, Goslar (DE)

(72) Inventors: Torsten SCHMIDT, Goslar (DE); Florian HAACKE, Goslar (DE); Björn RAIMER, Goslar (DE); Iryna SAVYCH, Clausthal-Zellerfeld (DE); Sarah WÖLPER, Braunschweig (DE)

(21) Appl. No.: 17/642,044

(22) PCT Filed: Sep. 14, 2020
(86) PCT No.: PCT/EP2020/075590

§ 371 Date: Aug. 10, 2022

(30) Foreign Application Priority Data
Sep. 13, 2019 (DE) 10 2019 124 648.2

(51) Int. Cl. C09D 4/06

(52) U.S. Cl. CPC C09D 4/06

(57) ABSTRACT

The invention relates in a first aspect to a radiation-curable (meth)acrylate-based paint system, comprising a (meth)acrylate-based paint component, a fluorinated monomer, oligomer or polymer as an additive; a siloxane monomer, oligomer or polymer as an additive; and solvents and/or reactive diluents. According to another aspect, the invention relates to a method for producing a radiation-cured (meth)acrylate coating for forming a surface on an article. Lastly, the invention relates to correspondingly coated articles and to the use of the radiation-curable paint system according to the invention.

The present invention relates in a first aspect to a radiation-curable coating system based on (meth)acrylate, comprising a coating component based on (meth)acrylate; a fluorinated monomer, oligomer or polymer as additive; a siloxane monomer, oligomer or polymer as additive; and solvent and/or reactive diluent. In a further aspect a method is provided for producing a radiation-cured (meth)acrylate coating for forming a surface on an article. Lastly described are articles coated accordingly, and also the use of the radiation-curable coating system of the invention.

### PRIOR ART

On optical surfaces, dust, dirt and other impurities resulting from the surroundings form soiling which is unwanted on the surfaces and must be removed. The properties of these optical surfaces are also impaired by the presence of fluids, such as raindrops or moisture condensation, such as fog, in the vehicle sector, for example, where headlights or sensors forming part of the continually advancing automation are among components to require optical surfaces.

Such soiling on the external surface is a problem in particular for those surfaces which are at least partly transparent. Dirty headlights are considered a safety risk by insurers and the industry, and appropriate countermeasures are needed. Visibility is essential, though, for headlights and also for sensors and cameras as are installed in vehicles, for example. Attempts are made accordingly to keep these surfaces free from soiling or low in soiling by means of cleaning systems. A result of this, however, is that further components must be included in the vehicle, for example, which not only take up space but also represent additional weight. This goes against the requirements in the automobile industry, for example, to reduce CO₂ emissions. Such mechanical cleaning systems, moreover, are not always effective, particularly in the case of small surfaces and nonplanar surfaces, such as those with undercuts. Alternatively to these mechanical cleaning systems there are various coatings on the market which are intended to reduce adherence of the soiling and other environmental influences to the surface, in order first to reduce the adherence and secondly to improve its removal when adherence is present. Various antimist coatings have been proposed, examples being coatings which are very oleophobic and to which deposits do not permanently attach. There are also coatings whose function is to reduce scratching on transparent surfaces, for vehicles, for example, but also for cellphones, TV sets and other technical devices, so that, for example, fingerprints are less visible and dust accumulation is reduced, or these adversities are easier to remove.

A problem affecting the solutions currently on the market, however, is usually that they lose their properties in a relatively short time after exposure to weathering or similar influences, and are therefore not suitable particularly for exterior applications.

Specifically in the automobile industry, however, the use of these components or articles with contact with the exterior is unavoidable, and so coatings and coating systems that are on the market, based usually on surface-coating materials, are not suitable for the coating of optical surfaces. The automobile industry in particular, however, requires solutions which ensure that these optical surfaces remain dirt-free over a long period and exhibit, furthermore, enhanced resistance, especially scratch resistance. This is also the case in particular for the optical surfaces of the sensors and cameras, since autonomous driving by vehicles requires such sensors and cameras.

It is known practice to modify surface properties of substrates in a targeted way by means of plastics-based coatings. These plastics-based coatings are also referred to as surface coatings or films. The coatings also referred to hereinafter as polymer coatings or single coatings are frequently coatings which are cured after application and whose possible components include epoxides, polyurethanes, polyacrylates, mixed systems, such as isocyanate-cured hydroxyacrylates, polycarbonates and the like. Curing is usually accomplished thermally or by radiation. These polymer coatings are intended first to reduce the soiling and secondly to improve the scratch resistance of these surfaces. The surfaces, including optical surfaces, are intended here to permit scratchproof coatings on relatively soft plastics, for example, such as polymethyl (meth)acrylate, UV-protective coatings and antifog coatings (for instrument covers, optical surfaces on vehicle sensors and vehicle headlights, and other articles, for example), with at least partly transparent surfaces.

There is therefore a need to provide dirt-repellent and scratchproof coatings for surfaces, such as optical surfaces, for headlights and sensors, for example, which have long durability. Such coated surfaces are needed particularly in the automobile industry. Surface coatings of this kind are required to exhibit a dirt-repellent effect in conjunction as far as possible with good resistance to hydrolysis. These surfaces are to exhibit reduced dirt pickup characteristics, improved cleanability, but in particular a long-term resistance in the exterior sector with good transparency. The good transparency also requires, in particular, a high scratch resistance.

Existing solutions with hard coatings which exhibit good scratch resistance do not meet the requirements in relation to the dirt pickup characteristics.

There is therefore a need for coating systems which are suitable in particular for optical surfaces, for providing the latter with improved scratch resistance and low dirt pickup characteristics and hence overall with improved cleanability, with this coating at the same time having long-term resistance, particularly with respect to outdoor weathering.

Substrates with antifog coatings, and corresponding production methods and also components, have been described in the prior art. DE 10 2013 004 925 B4, for instance, describes corresponding methods and components wherein a coating system with polymer coating material as base component and antimist additive is provided.

Scratchproof and flexible UV resins with hard and soft phases have been described in the prior art, with such coating systems being utilized, for example, for UV coating in the automotive sector for the purpose of increasing the scratch resistance of polycarbonate lenses in headlights. With headlights in particular, resistance to scratches is an important aspect; damage and hence optical impairments, as when the vehicles are cleaned in car washes, for example, play an important part.

EP 2 650 337 A1 describes flexible UV-curable coating compositions having a polyfunctional acrylate monomer component and an amino-organo-functional silane component, organic solvent components, an acid, a colloidal silica component and polyfunctional urethane acrylate oligomer component. These coatings, however, fail to meet the necessary requirements in terms of the capacity of the surfaces to pick up dirt.

### DESCRIPTION OF THE INVENTION

It is an object of the invention to provide suitable, radiation-curable coating systems which are dirt-repellent and scratch-resistant as coatings for at least partly transparent surfaces, particularly in the exterior sector. In particular these coatings also preferably exhibit good hydrolysis resistance.

This object is achieved in accordance with the invention with a radiation-curable coating system as claimed in claim 1 and with a method for producing a coating on an article as claimed in claim 13, and also with articles as claimed in claim 19 comprising the radiation-cured coating system of the invention. The new use of this coating system of the invention for coating articles, especially at least partly optically transparent articles, is described in claim 22.

The requirements imposed on the coating in terms of long life and dirt pickup characteristics are exacting: the coating is to exhibit improved cleanability and long-term resistance to exterior weathering in the case in particular of transparent surfaces. In the interior sector, the intention is to display good hydrolysis resistance and a dirt-repellent effect.

This is achieved in accordance with the invention with a radiation-curable coating system based on (meth)acrylate, comprising:
a coating component based (meth)acrylate;
a fluorinated monomer, oligomer or polymer as additive;
a siloxane monomer, oligomer or polymer as additive; and
solvent and/or reactive diluent.

It has emerged that the radiation-curable coating system of the invention based on (meth)acrylate enables a reduction in the dirt pickup behavior with improved cleanability at the same time. Furthermore, this coating system permits permanent, scratchproof but also flexible and crack-insensitive coating for surfaces, with long-term resistance, in particular for at least partly optically transparent surfaces.

The radiation-curable coating system of the invention based on (meth)acrylate in one embodiment is one wherein the coating component based on (meth)acrylate is one based on (poly)urethane (meth)acrylate. The coating system is therefore a radiation-curable coating system based on (poly)urethane (meth)acrylate.

In one embodiment the coating systems in question are more particularly aliphatic coating systems, such as aliphatic (poly)urethane (meth)acrylates, with the coating component being one based on aliphatic (poly)urethane (meth)acrylate.

In one embodiment the radiation-curable coating system of the invention based on (meth)acrylate is one wherein the coating component is one having a first fraction with highly functionalized (meth)acrylate basis, more particularly highly functionalized polyurethane (meth)acrylate basis. A highly functionalized (meth)acrylate of this kind, more particularly a polyurethane (meth)acrylate, has a functionality of 6-10.

The expression “functionality” refers presently to the number of bonds which a monomer, or the repeating unit thereof in a polymer, enters into with respect to other monomers. In the case of a highly functionalized P acrylate as oligomer, such as the Ebecryl used here, the oligomer as a unit has a corresponding functionality.

A second component is a coating component based on (meth)acrylate, more particularly based on polyurethane (meth)acrylate, more particularly based on polyurethane (meth)acrylate with low functionality, having a functionality of 1-5.

Illustrative compounds in this respect are as follows: aliphatic, high-functionality and low-functionality urethane (meth)acrylates, e.g., Ebecryl from Allnex.

The goal of developing the radiation-curable coating system of the invention is to provide coatings which allow an improvement in cleaning, by lowering the surface energy, for example, as achieved by coating of such surfaces. For plastics surfaces in particular, such as those of polycarbonate, PMMA (polymethyl(meth)acrylate), SMMA (styrene-methyl (meth)acrylate), acrylonitrile-styrene-acrylate copolymer (ASA), polyurethane (PU) or polyester as surfaces, more particularly at least partly optically transparent surfaces.

In contrast to the coatings from the prior art, which usually display their antisoiling properties for no longer than 6 months under real environmental conditions, the radiation-curable coating system of the invention permits the formation of coatings which allow not only reduced dirt pickup characteristics but also high scratch resistance over a relatively long period of at least one year.

Furthermore, these coatings obtained from the coating system of the invention exhibit outstanding hydrolysis resistance. This is useful particularly not least in the interior sector, since a dirt-repellent effect in combination with hydrolysis resistance is desirable in humid areas or in areas of increased soiling, such as in the kitchen area, with high atmospheric humidity and possibly lipid-containing constituents in the air. Suitable surfaces in this context are, in particular, transparent surfaces, of the kind present in displays, more particularly touch-sensitive displays, referred to as touch-displays. The coatings of the invention formed from the coating systems of the invention exhibit an enhanced dirt-repellent effect in conjunction with hydrolysis resistance.

Through combination of fluorinated monomer, oligomer or polymer as additive with an additive based on siloxane monomer, oligomer or polymer with the coating component based on (meth)acrylate, more particularly based on polyurethane (meth)acrylate, it is possible to achieve this resistance not only to dirt pickup characteristics but also scratch resistance and especially flexibility in conjunction with reduction in the cracking characteristics.

In one embodiment of the present invention the fluorinated monomer, oligomer or polymer additive is one which is a fluorinated (poly)urethane (meth)acrylate oligomer, e.g., an aliphatic (poly)urethane (meth)acrylate. These oligomers permit particularly effective attachment to the further components of the radiation-curable coating system of the invention, particularly since the coating component is one based on methacrylate, more particularly based on (poly)urethane (meth)acrylate, such as aliphatic embodiments thereof. This fluorinated monomer, oligomer or polymer additive improves the hydrophobicity and oleophobicity of the coating obtainable with the radiation-curable coating system, and therefore permits a reduction in the dirt pickup characteristics.

Surprisingly it has now emerged that a combination thereof with siloxane monomer, oligomer or polymer as additive provides not only the reduction in the dirt pickup characteristics, brought about by the fluorine-based additive, but also an improvement in the long-term resistance, specifically the scratch resistance and crack-insensitivity. In one embodiment the silicone-based additives, i.e., the siloxane monomer, oligomer or polymer additives, are oligomers, more particularly oligomers based on (meth)acrylate, such as oligomers of siloxane-polyurethane (meth)acrylate.

Suitable silicone-based additives permit copolymerization with the coating component and the fluorine-based additive.

The assumption here is that on curing/full polymerization, the radiation-curable coating system in accordance with the present invention forms different regions in the coating itself. Hence it is assumed that the uppermost region of this coating, the outer surface, has in particular a relatively high fraction of the fluorine-based additive, whereas in the underlying region the siloxane (silicone)-based additives are present in combination with the coating component.

The solvent and/or the reactive diluent present in the radiation-curable coating system of the invention are in one embodiment at least one solvent of a mixture of two alcohols, more particularly a combination of methoxypropanol and ethanol. Other suitable alcohol-based solvents are, for example, propanol or ethylene glycol butyl ether.

The coating system of the invention may further comprise a solvent of an ester, such as ethyl acetate. Such esters, such as ethyl acetate, permit better connection of the coating to the surface of the article that is to be coated.

The expression “reactive diluents” refers presently to components or substances which lower the viscosity of a coating material for processing and through copolymerization become part of the coating material on the subsequent curing of the coating material. Suitable reactive diluents include 1,6-hexanediol diacrylate or trimethylolpropane triacrylate.

Besides the stated components, the radiation-curable coating system of the invention may comprise further customary ingredients, such as UV absorber and UV stabilizer. Suitable components also include UV stabilizers such as HALS. Suitable UV absorbers are known UV absorbers, such as Hostavin from Clariant, for example.

The radiation-curable coating system of the invention in one embodiment further comprises corresponding photoinitiators, which initiate the curing of the coating system following excitation by UV light. Suitable photoinitiators include, for example, 1-hydroxycyclohexyl phenyl ketone.

In one embodiment the radiation-curable coating system of the invention based on (meth)acrylate is one wherein the fraction of the coating component based on (meth)acrylate is 15 to 30 wt %, based on the total amount of the coating system, and/or the amount of the solvents and/or reactive diluent is 50 to 80 wt %, based on the total amount of the coating system.

In one embodiment the radiation-curable coating system of the invention based methacrylate comprises:
15 wt % to 30 wt % of a mixture of a highly functionalized (poly)urethane-(meth)acrylic resin and a low-functionalized (poly)urethane-(meth)acrylic resin;
50 wt % to 80 wt % of solvent comprising mixtures of alcohols and esters, preferably comprising ethyl acetate, methoxypropanol and ethanol, and also reactive diluent;
1 wt % to 5 wt % of a UV absorber;
0.1 wt % to 5 wt % of a UV stabilizer;
0.5 wt % to 5 wt % of a photo initiator;
0.01 wt % to 5 wt % of a fluorinated monomer, oligomer or polymer as additive;
0.01 wt % to 5 wt % of a siloxane monomer, oligomer or polymer as additive;
0 wt % to 10 wt % of an adhesion promoter.

In one embodiment here it is preferable for the fluorinated monomer, oligomer or polymer as additive to be present in an amount between 0.01 wt % to 5 wt %, such as 0.05 to 3 wt %, e.g., 0.07 to 2 wt %, based on the total amount of the coating system.

The siloxane additive, more particularly in the form of the siloxane monomer, oligomer or polymer based on (meth)acrylate, such as based on polyurethane (meth)acrylate, is present in a range from 0.01 wt % to 5 wt %, such as 0.1 to 4 wt %, e.g., 0.25 wt % to 3 wt %, based on the total amount of the coating system. In one embodiment the ratio here of siloxane additive to fluorinated additive is in a range from 1:2 to 3:1 based on weight percent.

UV absorber, UV stabilizer and photoinitiator, if present, are used in customary amounts; these corresponding amounts are known to the skilled person.

In one embodiment the solvent is one from a mixture of methoxypropanol, ethanol and ethyl acetate, with the fractions of methoxypropanol here being greater than the fractions of ethanol; the fractions of ethanol are greater than the fractions of ethyl acetate.

For example, the fractions of methoxypropanol to ethanol are in a range from 1.1:1 to 5:1 and the fractions of ethanol to ethyl acetate are in a range from 1.1:1 to 5:1.

The radiation-curable coating system of the invention may additionally contain an adhesion promoter. Such adhesion promoters include aminosilanes.

Coating systems with relatively high solvent fractions permit flow coating and the production of coatings which have a relatively low thickness.

In one embodiment the coating system may further comprise nanoparticles.

In a further aspect, the present invention constitutes a method for producing a preferably flexible and preferably crack-insensitive, radiation-cured (meth)acrylate coating for permanently forming a surface, more particularly a soiling-repellent and scratch-resistant surface, having preferably chemical resistance and UV resistance properties, on an article, comprising:
mixing the components of the radiation-curable coating system according to the present invention;
applying this coating system at a temperature of 10° C. to 30° C. to the article;
heating the coated article for evaporating off the solvent without UV irradiation, more particularly under UV protection, more particularly heating to 25° C. to 90° C., such as 40° C. to 80° C.;
radiation-crosslinking the coating system on the article by UV curing.

This method of the invention permits the provision of permanent coatings as a surface on an article having outstanding properties in terms of scratch resistance and also dirt pickup characteristics. The method of the invention additionally permits the production of flexible and crack-insensitive coatings, for the permanent formation of this coating as a surface. This surface is preferably one which has chemical resistance and/or UV resistance properties.

These coatings may be formed at least partly or completely on at least one surface of the article.

In a first step here, the radiation-curable coating system of the invention is provided by mixing of the components. This mixing takes place in accordance with known methods. The mixing takes place preferably under UV protection.

A specific sequence of the mixing of the individual components is not necessary.

This mixture is then applied to the article that is to be coated. The applying here may take place wholly or partly to the article or the substrate. The applying takes place at a temperature of preferably 10° C. to 30° C. The applying takes place in accordance with known methods. These coating methods include application of the coating system to the article by flow coating, spraying, dipping, spin coating, knife coating or roll-to-roll. A coating method is selected according to the articles to be coated. This coating is accomplished preferably such that with no UV irradiation, more particularly under UV protection, the radiation-curable coating system is applied to the article.

In a subsequent step the solvent is evaporated off. This evaporation typically entails heating of the coated article. This heating is an increase in temperature during the step of applying the radiation-curable coating system of the invention and an evaporative removal step with heating. The heating is more particularly to 25° C. to 90° C., such as 25° C. to 60° C. or 40° C. to 80° C. The heating may take place, in one embodiment, slowly, e.g., with a temperature change of not more than 3° C. per minute, such as not more than 2° C. per minute.

This means that evaporative removal or flash removal of the solvent may take place when the coating system is applied and may take place, for example, at a first temperature, such as the ambient temperature during the application, for at least 2 min, for not more than 24 hours, for example, and subsequently with heating, as described.

During the evaporation of the solvent, the coating is formed on the article or substrate. This coat more particularly is a functional polymer layer having multiple regions. In a topmost region, which forms the outward surface of the coating, there are found, in particular, the fluorinated additives together with the coating component based on (meth)acrylate, more particularly based on PU (meth)acrylate. Following this is a region which in particular mediates the scratch resistance of the coating. In this region, relative to the other regions, the siloxane monomer, oligomer or polymer additives are enriched, together with the coating component based on (meth)acrylate, more particularly based on PU (meth)acrylate.

During the operation of coating with the evaporative removal of the solvent, additionally, a penetration layer is preferably formed, also referred to as IPL layer (intrapenetration layer). This penetration layer is a layer which penetrates into the article to be coated, with a consequent mixed region of the components of the coating system and the article to be coated. The result of this is more effective adherence. The formation of the IPL is promoted, for example, by corresponding solvents, such as ethyl acetate. The ethyl acetate allows the surface of the article or substrate to undergo incipient etching, for example, so that the coating system is able with the substrate to form the IPL layer. Identical effects are possible with reactive diluents or else in the context of corresponding conditions during the curing operation.

In one embodiment this penetration layer between coating and the article to be coated is 0.5 μm to 3 μm thick, such as 1 μm, for example. The coating itself is in one embodiment one having a film thickness of 5 to 25 μm, e.g., 8 to 20 μm, such as 10 to 15 μm. In one embodiment the film thickness is 10 to 12 μm. This film thickness includes the thickness of the penetration layer.

The evaporative or flash removal of the solvents takes place for example in a heating facility, such as an oven.

The heating for evaporating off the solvent here takes place in one embodiment for at least 2 min, such as for at least 3 min. In a further embodiment the heating takes place for not more than 8 min, such as not more than 5 min. The heating takes place more particularly in a range from 2 to 5 min. As a result, the penetration layer between coating and article or substrate to be coated is developed particularly well.

If the flash removal temperature is too high, a haze may occur, such as at a flash removal temperature of more than 90° C., such as more than 80° C. or higher, for example. After evaporation has taken place, the coated article or substrate is subjected to radiation crosslinking by UV irradiation. This UV irradiation, also referred to as UV curing, takes place in one embodiment such that the energy input is at least 2000 mJ/cm², such as at least 3000 mJ/cm², e.g., at least 4000 mJ/cm², more particularly at least 5000 mJ/cm². The energy input is selected such that complete or near-complete UV curing occurs, in order to guarantee the scratch resistance. Too high an energy input, however, may result in the coating system being more brittle.

The UV curing may follow directly the heating for evaporating off the solvent, meaning that the coated article is still in the heated state; the radiation crosslinking may also take place at room temperature after cooling off the coated article, as during transport from the heating location to the location of the radiation crosslinking, for example.

The UV curing may take place by means of UV emitters, for example, such as a mercury lamp.

The coating thus obtained in accordance with the invention on the substrate is notable for high scratch resistance. Furthermore, the dirt pickup characteristics are diminished and the coating is clear and transparent. As a result, an improved pixel-free and effect-free coating is achieved, which exhibits outstanding long-term resistance. Advantageously, furthermore, the resistance to hydrolysis is present.

The substrate or the article itself may in one embodiment have been pretreated—for example, the article or substrate is pretreated by means of ionized compressed air or by plasma treatment. Alternatively or additionally the surface of the article may be cleaned using suitable fluids, such as alcohols, e.g., isopropanol.

In a further aspect a coated article obtainable in accordance with the invention is provided. This at least partly coated article, also referred to below synonymously as coated substrate, obtainable with the method of the invention, is notable for dirt-repellent and scratchproof and optionally hydrolysis-resistant coating. Furthermore, it exhibits good hydrolysis resistance and is preferably also chemical-resistant and UV-resistant.

The articles and substrates coated in accordance with the invention, furthermore, are durably coated and are resistant to outdoor weathering. They are also notable for preferably having outstanding flexibility and crack-insensitivity.

Flexibility and crack-insensitivity of this kind are important in particular for articles which are bent or under stress during installation or during use. This is the case particularly for headlights or sensor covers and also for lamps. The combination of flexibility and crack-insensitivity is essential here to ensure a high level of resistance with respect to environmental effects and outdoor weathering.

In one aspect the coated article is at least partly optically transparent in the IR and VIS spectrum. The resistance and flexibility with crack-insensitivity are relevant in particular for transparent covers of headlights or sensors.

In one embodiment here the coated article is an optical lens, a vehicle light lens, spectacle lenses, prisms, a window, a plastics article, more particularly a headlight, a lamp or a sensor, lamp components, motor vehicle components, or measuring instruments.

The coated article may, furthermore, be an at least partly transparent display, such as a touch-sensitive display, referred to as a touch-display. Articles of this kind with such surfaces are nowadays used in a wide variety of different sectors, including, for example, in wet-room areas or in areas of increased soiling, such as in the kitchen, in the bathroom, etc.

In one embodiment the coated article or coated substrate is a plastics article or plastics substrate. This plastics article or plastics substrate is formed of polycarbonate, PMMA (polymethyl methacrylate), SMMA (styrene-methyl methacrylate), ASA (acrylonitrile-styrene-acrylate copolymer), polyurethane (PU), polyester or mixtures thereof. The coated surface more particularly is optically transparent, especially in the IR and VIS spectrum.

In one embodiment the article or substrate in question is a headlight, more particularly in the automotive sector; in another embodiment it comprises sensors, more particularly those which are used in the exterior sector. These sensors include optical sensors, including cameras.

The present invention lastly provides the use of the preferably flexible and preferably crack-insensitive, radiation-curable coating system according to the present invention for coating at least partly optically transparent articles of glass and/or plastic. These articles/substrates are, more particularly, headlights and sensors.

Use in accordance with the invention is appropriately, in particular, as a coating which is used both in the exterior sector and in the interior sector.

In the text below, the present invention is elucidated in more detail with examples, without being confined to these examples.

### Coating Composition:

### Formula According to the Invention

| | | Mass |
|---|---|---|
| Constituent | Manufacturer/Seller | [g] |
| Ebecryl 8602 | Allnex | 16.5 |
| Ebecryl 4513 | Allnex | 5.5 |
| Methoxypropanol | CG Chemikalien | 43.11 |
| Ethanol | CG Chemikalien | 14.37 |
| Ethyl acetate | Merck | 2.87 |
| 1,6-Hexanediol diacrylate | TCI | 6.6 |
| Hostavin | Clariant | 1.2 |
| HS 508 | Krahn Chemie | 0.4 |
| 1-Hydroxycyclohexyl phenyl ketone | TCI | 2 |
| SFA 480 | Shin A&TC/Polygon | 0.074 |
| SUO S600NM | Shin A&TC/Polygon | 0.223 |

The reference coating used is a UV-curing hard coat (UVHC 3000 K from Momentive, Leverkusen, Germany).

### Determination of Physical and Mechanical Properties:

The parameters were determined in accordance with a standard from the automotive sector, TL211. Further test criteria employed were TL52437 for headlights in the exterior sector, and TL226. The cleanability via the adherence method and the cleanability and chemical resistance were determined by means of TL211. The weathering resistance was tested according to PV1200 in accordance with TL211 using 20 cycles.

The table below sets out the aforesaid standards, criteria and specifications for the composition of the invention.

| Standard | Criterion | Specification |
|---|---|---|
| TL211 Tab.2 No.1 | Optical quality | clear layer, visual |
| | | investigation |
| TL211 Tab.2 No.2 | Adhesion, DIN EN ISO 2409 | cross-cut test ≤1 |
| TL211 Tab.2 No.3 | Constant condensation conditions, | no detachment, adhesion in |
| | DIN EN ISO 6270-2, 240 h | cross-cut test ≤1, no |
| | | change in optical quality |
| TL211 Tab.2 No.4 | Climatic cycles, PV 1200, | no change in optical quality |
| | 20 cycles | |
| TL211 Tab.2 No.5 | Temperature change | no change in optical quality |
| | 240 h 90° C., 30 min RT, | |
| | 24 h −40° C., 30 min RT | |
| TL211 Tab.2 No.8 | Chemical resistance to fuel, | no change in optical quality |
| | isopropyl alcohol, sulfuric acid, | |
| | hydrochloric acid, water, | |
| | pancreatin, tree resin, protective | |
| | transit film | |
| Surface energy | Contact angle measurement with | water contact angle >100° |
| (by OWRK method) | respect to water and hexadecane | hexadecane contact angle |
| | | >50° |
| Cleanability | Removal of Maxx 224M red | capacity to be wiped off |
| (see below) | permanent marker | without residue using cotton |
| | | cloth |

Comparison took place with the stated commercial product UVHC 3000 K from Momentive.

### Cleanability

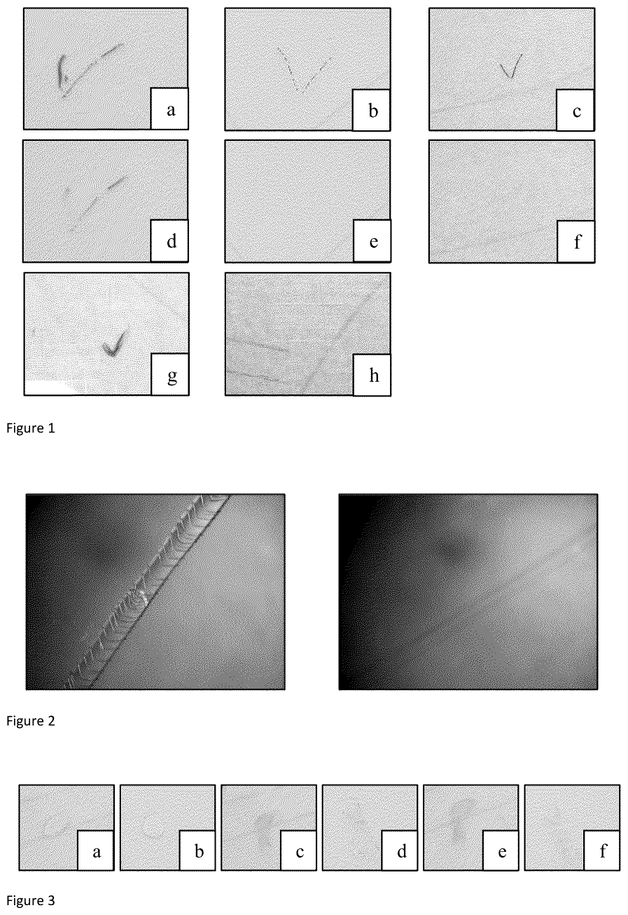

The cleanability of the composition of the invention relative to the abovementioned commercial product is show in FIG. 1.

For this purpose the test was carried out as follows: using a permanent marker, a line around 2 cm long is applied to a coated substrate. The line is dried at RT for 1 min. The substrate is subsequently cleaned by being wiped down once with a cloth.

FIG. 1: test results of the cleaning test with UVHC 3000 K before (a) and after (d) cleaning, after climatic cycling test (PV 1200, 20 cycles) (g), coating composition of the invention before (b) and after (e) cleaning, after climatic cycling test (PV 1200, 20 cycles) (h); composition according to the invention before (c) and after (f) cleaning.

For Further Validation, the Following Tests were Carried Out:

TABLE 2
Tests for validating the composition of the invention

| Standard | Criterion | Specification |
|---|---|---|
| Soil adherence I | Removal of tree resin | Residue-free |
| Soil adherence II | Removal of standard | Residue-free |
| | soiling ECE R45 | |
| TL226 Tab. 3 No.3 | Scratch resistance | No scratches or erosion |

### Scratch Resistance:

FIG. 2 shows the scratch resistance in the form of a microscope picture following conditioning with 20 cycles according to PV1200. FIG. 2a shows the scratch resistance of the commercially available comparative coating, which FIG. 2b shows the scratch resistance of the coating according to the invention. In 2a there is rippling apparent in the scratch track, whereas in 2b only a slight impression track is visible.

DIN EN ISO 1518 describes a method for determining the scratch resistance with constant load. In this method, the resistance to the penetration of a test point is determined. The method may alternatively be carried out as a “Yes/No” test with only one specified load or with the objective of determining a minimum load under which the test point penetrates through the coating down to the substrate.

FIG. 3 shows the soiling and cleanability with respect to resins. FIGS. 3a, 3c and 3e show the removability for commercial product, whereas better removal of the soiling is possible with the product according to the invention under the same conditions; see FIGS. 3b, 3d and 3f. The tree resin consists of a 1:1 mixture of rosin and pine oil, and was dried at 80° C. for 4 h after application. This was followed by wiping, first dry (3c, 3d) and then with water (3e, 3f).

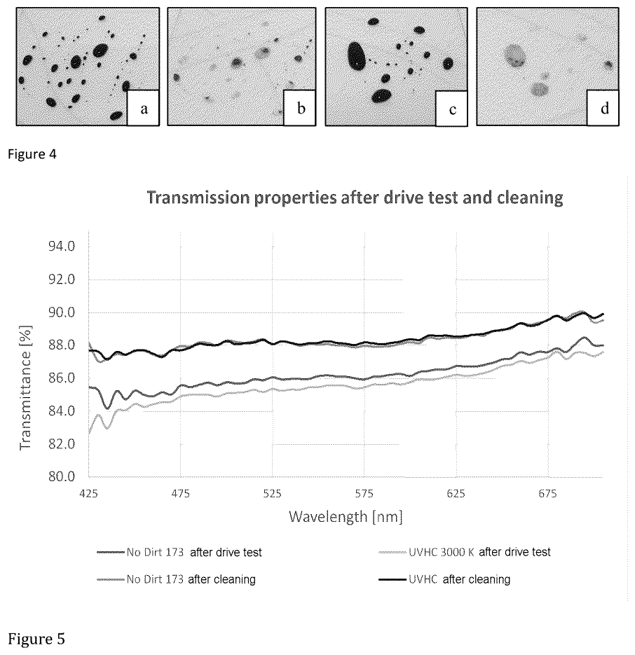

FIG. 4, lastly, shows the removal of a dried ECE R45 soil suspension. FIGS. 4a and 4b show the soiling (4a) after drying and after cleaning for the commercial product (4b); FIGS. 4c and 4d show the results with a coating according to the invention after application (4c) and after drying and cleaning by means of compressed air (4d).

The advantageous properties of the coating system of the invention are clearly apparent. This system is notable for reduced dirt pickup and improved cleanability. It additionally possesses a better long-term resistance under outdoor weathering.

### Determining the Long-Term Resistance of the Coating

As part of a long-term test, the dirt pickup and cleanability of coated surfaces were investigated. This was done using coated surfaces on a polycarbonate substrate, which were mounted on a vehicle over a year and tested over around 48 000 kilometers as part of a drive test. It was found that around 40% more area remains transparent, i.e., is less contaminated. Additionally it was found that, on determination of the transmission properties, the dirt pickup was lower in comparison to conventional coatings. The conventional coating used was the above-described UVHC 3000 K from Momentive. FIG. 5 here shows the transmission properties of the transparent, coated substrates after the drive test, before and after cleaning. It is clearly apparent that the coating composition of the invention exhibits improved transmittance as a coating, relative to the conventional coating systems comparatively, in this case UVHC 3000 K. After cleaning of the coated surfaces, both coating systems exhibited substantially identical transmission spectra.

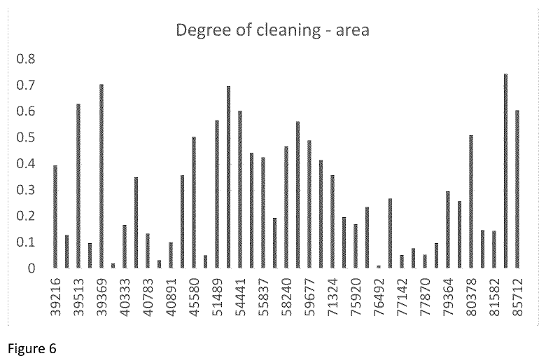

FIG. 6 shows the degree of cleaning of the area in comparison to the conventional product. Degree of cleaning here means that proportionally less area treated with the coating composition according to the invention is contaminated by insects, by comparison with conventional surfaces. On average 40% more area was uncontaminated and therefore transparent.

1. A radiation-curable coating system based on (meth)acrylate, comprising:
a coating component based on (meth)acrylate;
a fluorinated monomer, oligomer or polymer as a first additive;
a siloxane monomer, oligomer or polymer as a second additive; and
solvent and/or reactive diluent.

2. The radiation-curable coating system based on (meth)acrylate as claimed in claim 1, wherein the coating component based on (meth)acrylate is one based on (poly)urethane (meth)acrylate.

3. The radiation-curable coating system based on (meth)acrylate as claimed in claim 2, wherein the coating component based on (meth)acrylate is based on aliphatic (poly)urethane (meth)acrylate.

4. The radiation-curable coating system based on (meth)acrylate as claimed in claim 1 or 2, wherein the coating component based on (meth)acrylate, has a first fraction of a coating component with highly functionalized (meth)acrylate basis having a functionality of 6-10, and has a second fraction of a second component of the coating component based on (meth)acrylate with low functionality having a functionality of 1-5.

5. The radiation-curable coating system based on (meth)acrylate as claimed in claim 1 wherein the fluorinated monomer, oligomer or polymer as additive and/or the siloxane-containing monomer, oligomer or polymer as the first additive is one based on (meth)acrylate.

6. The radiation-curable coating system based on (meth)acrylate as claimed in claim 1 wherein the siloxane-containing monomer, oligomer or polymer as the second additive and/or the fluorinated monomer, oligomer or polymer as the second additive is an oligomer.

7. The radiation-curable coating system based on (meth)acrylate as claimed in claim 1 wherein the solvent comprises at least one mixture of two alcohols, more particularly a combination of methoxypropanol and ethanol.

8. The radiation-curable coating system based on (meth)acrylate as claimed in claim 1 wherein the solvent comprises an ester, such as ethyl acetate.

9. The radiation-curable coating system based on (meth)acrylate as claimed in claim 1 further comprising at least one component selected from the group consisting of a UV absorber and a UV stabilizer.

10. The radiation-curable coating system based on (meth)acrylate as claimed in claim 1 further comprising a photo initiator.

11. The radiation-curable coating system based on (meth)acrylate as claimed in claim 1 wherein the coating component based on (meth)acrylate is 15 to 30 wt % based on a total amount of the coating system, and/or an amount of the solvent and/or the reactive diluent is 50 to 80 wt % based on the total amount of the coating system.

12. A radiation-curable coating system based on (meth)acrylate, comprising
15 wt % to 30 wt % of a mixture of a highly functionalized (poly)urethane-(meth)acrylic resin and a low-functionalized (poly)urethane-(meth)acrylic resin;
50 wt % to 80 wt % of solvent comprising mixtures of alcohols and esters and also reactive diluent;
1 wt % to 5 wt % of a UV absorber;
0.1 wt % to 5 wt % of a UV stabilizer;
0.5 wt % to 5 wt % of a photo initiator;
0.01 wt % to 5 wt % of a fluorinated monomer, oligomer or polymer as a first additive;
0.01 wt % to 5 wt % of a siloxane monomer, oligomer or polymer as a second additive; and
0 wt % to 10 wt % of an adhesion promoter.

13. A method for producing a flexible and crack-insensitive, radiation-cured (meth)acrylate coating for permanently forming a surface having chemical resistance and UV resistance properties on an article, comprising:
mixing the components of the radiation-curable coating system as claimed in claim 1;
applying this coating system at a temperature of 10° C. to 30° C. to the article to form a coated article;
heating the coated article for evaporating off the solvent without UV irradiation to form a coating system; and
radiation-crosslinking the coating system on the article by UV curing.

14. The method for producing a radiation-cured (meth)acrylate coating as claimed in claim 13, wherein the UV curing takes place at elevated temperature to room temperature.

15. The method for producing a radiation-cured (meth)acrylate coating as claimed in claim 13, where the heating for evaporating off the solvent takes place for at least two minutes, wherein a penetration layer is formed between the coating and the article to be coated.

16. The method for producing a radiation-cured (meth)acrylate coating as claimed in claim 13, wherein each of the mixing of the starting materials, the coating, and the heating for evaporating off the solvents take place under UV protection.

17. The method for producing a radiation-cured (meth)acrylate coating as claimed in claim 13, wherein the applying of the coating takes place with a film thickness of 5-25 μm, and wherein a penetration layer between a coating and the article to be coated is 0.5 to 3 μm.

18. The method for producing a flexible, radiation-cured (meth)acrylate coating as claimed in claim 13 wherein the step of applying of the system to the article takes place by one or more of flow coating, spraying, dipping, spin coating, knife coating or roll-to-roll.

19. A coated article obtainable with a method as claimed in claim 13 optionally having chemical resistance and UV resistance properties, wherein said coated article is at least partly optically transparent in the IR and VIS spectrum.

20. The coated article as claimed in claim 19, wherein said coated article is an optical lens, a lamp lens, a window, a plastics article, a headlight, a lamp, or a sensor.

21. The coated article as claimed in claim 19, wherein said coated article is one which is used in a humid area or is one which is used in an interior area, or displays and/or touch-displays.

22. The coated article as claimed in claim 19 wherein the coated article or the surface of the coated article comprises polycarbonate, PMMA, SMMA, ASA, polyester, or PU.

23. A method of using the radiation-curable coating system as claimed in claim 1, comprising coating one or more surfaces of glass and/or plastic with the radiation-curable coating system.

24. A method of using the radiation-curable coating system as claimed in claim 1 on at least partly optically transparent articles of glass and/or plastic, comprising coating both exterior and interior sectors of the glass and/or plastic with the radiation-curable coating.
